(19) United States
(12) Patent Application Publication
(10) Pub. No.: US 2008/0211689 A1
(43) Pub. Date: Sep. 4, 2008

(54) Illegal-parking-management portable terminal, illegal-parking management method and computer program product

(75) Inventors: Kunikazu Takahashi, Kawasaki (JP); Tatsuya Kanda, Hino (JP); Masahiro Oota, Kawasaki (JP); Levan Higashigawa, Kawasaki (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); FFC LIMITED, Tokyo (JP)

(21) Appl. No.: 12/149,454

(22) Filed: May 1, 2008

Related U.S. Application Data
(63) Continuation of application No. PCT/JP2005/020236, filed on Nov. 2, 2005.

(51) Int. Cl. B60Q 1/48

(52) U.S. Cl. 340/932.2

(57) ABSTRACT

An illegal-parking-management portable terminal includes a storage unit, an extracting unit, and a selecting unit. The storage unit stores therein facility information on a facility relevant to illegal parking and an illegal-parking application rule that defines illegal-parking condition for each penalty article. The extracting unit extracts, from the facility information, information on a facility within a predetermined range from a position specified as a vehicle parking position on a map displayed on a display unit. The selecting unit compares the extracted information with the illegal-parking application rule, and selects a penalty article to be applied to illegal parking of a vehicle.

### BACKGROUND OF THE INVENTION

1. Field of the Invention

The present invention relates to a technology for supporting illegal-parking management.

2. Description of the Related Art

In recent years, management of illegally-parked vehicles has been partly transferred to the private sector, and parking attendants with a predetermined qualification check vehicles parked illegally. The parking attendants are those who have passed a qualification test, and have certain legal knowledge about illegal parking. However, in the present situation, complex road conditions make it difficult for the parking attendants to correctly determine whether unattended parked vehicles are against the parking rules, or which penalty article is applied. Therefore, there is a need of a technology for supporting parking attendants to perform illegal-parking management and facilitating the recognition of illegal parking.

For example, Japanese Patent Application Laid-open No. 2002-312897 discloses a conventional technology in which a navigation device installed on a vehicle reads a map information medium containing various types of traffic rule information such as an illegal-parking zone on a public street. The navigation device checks whether a target vehicle obeys traffic rules based on input from various sensors, and notifies a management center of violation information when the navigation device determines that the vehicle violates any traffic rule.

However, the conventional technology does not take into consideration the management of illegal parking, and therefore, cannot sufficiently support the illegal-parking management. Regarding illegal parking, there are a plurality of penalty articles as the basis of determining illegal parking, and a proper one of penalty articles needs to be selected. However, the conventional technology only enables detection of illegal parking, and cannot support the user to specify a penalty article.

To report illegal parking, a sketch of the location needs to be created. Creation of such a sketch is a very troublesome work depending on a road shape and the like. However, the conventional technology cannot facilitate the work.

### SUMMARY

It is an object of the present invention to at least partially solve the problems in the conventional technology.

According to an aspect of the present invention, there is provided an illegal-parking-management portable terminal that supports management of illegal parking. The illegal-parking-management portable terminal includes a storage unit that stores therein map information, facility information on a facility relevant to illegal parking, and an illegal-parking rule that defines illegal-parking condition for each penalty article; a display unit that displays a map based on the map information; an extracting unit that extracts, from the facility information, information on a facility within a predetermined range from a position specified on the map as a vehicle parking position where a vehicle is parked; and a selecting unit that compares extracted information with the illegal-parking rule, and, when the vehicle parking position is designated as an illegal parking area, selects a penalty article to be applied to illegal parking of the vehicle.

According to another aspect of the present invention, there is provided an illegal-parking management method for supporting management of illegal parking. The illegal-parking management method includes displaying a map; extracting, from facility information stored in advance, information on a facility within a predetermined range from a position specified on the map as a vehicle parking position where a vehicle is parked; comparing extracted information with an illegal-parking rule that defines illegal-parking condition for each penalty article; and selecting, when the vehicle parking position is designated as an illegal parking area, a penalty article to be applied to illegal parking of the vehicle.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an illegal-parking-management portable terminal according to an embodiment of the present invention;

FIG. 2 is an example of facility information shown in FIG. 1;

FIG. 3 is an example of an illegal-parking non-application rule shown in FIG. 1;

FIG. 4 is an example of a sketch object shown in FIG. 1;

FIG. 5 is an example of an illegal-parking application rule shown in FIG. 1;

FIG. 6 is a flowchart of a process procedure until display of a map to point a vehicle parking position;

FIG. 7 is an example of map display by a map display unit shown in FIG. 1;

FIG. 8 is a flowchart of a process procedure until display of candidates of a penalty article to be applied to an unattended parked vehicle;

FIG. 9 is a flowchart of a process procedure until recording of information concerning illegal parking as illegal-parking information shown in FIG. 1;

FIG. 10 is an example of an illegal-parking information screen; and

FIG. 11 is a functional block diagram of a computer that executes an illegal-parking management program.

### DETAILED DESCRIPTION OF THE PREFERRED EMBODIMENTS

Exemplary embodiments of the present invention are explained in detail below with reference to the accompanying drawings.

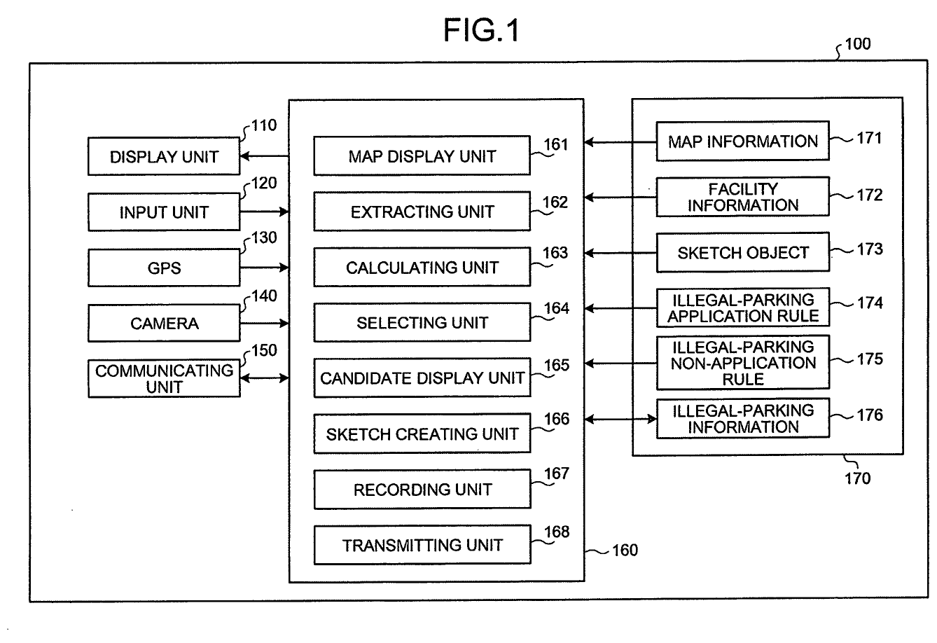

FIG. 1 is a functional block diagram of an illegal-parking-management portable terminal 100 according to an embodiment of the present invention. The illegal-parking-management portable terminal 100 is configured to be carried by a user, such as a policeman or a parking attendant engaged in management of illegal parking of vehicles to support him/her to determine whether an unattended parked vehicle is violating parking regulations. When the vehicle is violating parking regulations, for example, the illegal-parking-management portable terminal 100 reports this to the user.

The illegal-parking-management portable terminal 100 includes a display unit 110, an input unit 120, a Global Positioning System (GPS) 130, a camera 140, a communicating unit 150, a control unit 160, and a storage unit 170.

The display unit 110 displays image information and text information, and includes a liquid-crystal display or the like. The input unit 120 is used by a user to input information and work instructions, and includes a keypad or the like. The display unit 110 and the input unit 120 can be configured integrally like a touch panel.

The GPS 130 obtains a current position by using satellites. The camera 140 is used to pick up an image of the location of illegal parking. The communicating unit 150 is a communication device that transmits illegal-parking data stored in the illegal-parking-management portable terminal 100 to a central processing unit or the like. The GPS 130, the camera 140, and the communicating unit 150 are not necessarily required to be incorporated in the illegal-parking-management portable terminal 100, and can be externally connected to the illegal-parking-management portable terminal 100.

The control unit 160 controls the total of the illegal-parking-management portable terminal 100, and includes a map display unit 161, an extracting unit 162, a calculating unit 163, a selecting unit 164, a candidate display unit 165, a sketch creating unit 166, a recording unit 167, and a transmitting unit 168.

The map display unit 161 displays a map in the display unit 110 based on map information 171 stored in the storage unit 170. The map display unit 161 displays, in the initial state, a map of around the current position obtained by the GPS 130. The map is scrolled, zoomed in/out, etc. in response to input provided through the input unit 120. The map display unit 161 obtains a position that the user points on the map as a vehicle parking position, i.e., a position where a vehicle is parked, and outputs the vehicle parking position to the extracting unit 162.

The extracting unit 162 extracts, from facility information 172 in the storage unit 170, information on a road shape such as crossing within a predetermined latitude and longitude based on the vehicle parking position received from the map display unit 161, and information on facilities including a traffic signal and a fire hydrant (hereinafter, the term “facility” refers to both road shape and facility unless otherwise specified).

The extracting unit 162 refers to an illegal-parking non-application rule 175 in the storage unit 170, checks whether each facility extracted in the above is at the outside of the time zone of illegal parking, and performs the process of excluding the facility from the extracted result, when the facility is at the outside of the time zone of illegal application.

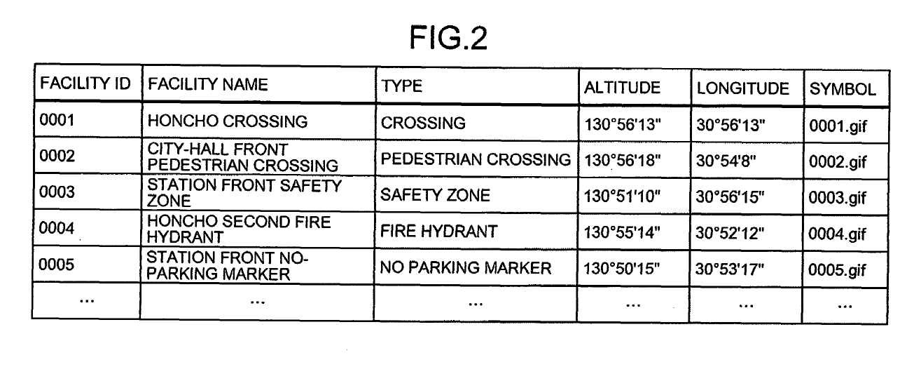

FIG. 2 is an example of the facility information 172. The facility information 172 is registered in advance and indicates facilities related to illegal parking. As shown in FIG. 2, the facility information 172 includes items of facility ID, facility name, type, latitude, longitude, and symbol. Data is generated for each facility.

The facility ID identifies a facility. The facility name is a name of a facility. The type is an item used as a key at the time of comparing the facility information with an illegal-parking application rule 174, and predetermined words such as “crossing” and “pedestrian crossing” are set. The latitude and longitude express latitude and longitude of an address of a facility. The symbol is a name of image data used to display the facility on the map.

Data in the first row in FIG. 2 expresses a facility identified by a facility ID of “0001”. The facility name of this facility is “Honcho crossing”, and the type is “crossing”. This facility is located at the latitude “130° 56′ 13″ ”, and the longitude “30° 56′ 13″ ”, and is a symbol displayed using image data having a name of “0001.gif” on the map.

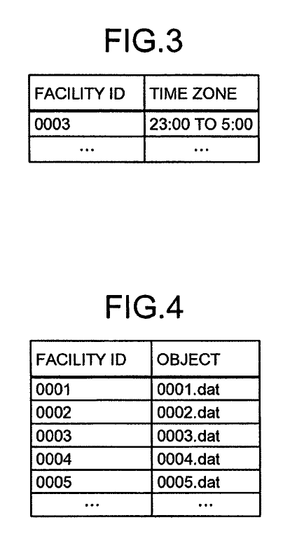

FIG. 3 is an example of the illegal-parking non-application rule 175. The illegal-parking non-application rule 175 includes registered information on a time zone in which the facility does not constitute illegal-parking condition, i.e., condition under which a vehicle is identified as illegally parked. As shown in FIG. 3, the illegal-parking non-application rule 175 includes items of facility ID and time zone. Data is generated for each facility.

The facility ID identifies a facility, and corresponds to the facility ID of the facility information 172. The time zone indicates a time zone in which the facility does not constitute the illegal-parking condition.

The data in the first row in FIG. 3 means that a facility identified by a facility ID of “0003” does not constitute the illegal-parking condition during the time zone of “23:00 to 5:00”. Details of the facilities identified by the facility ID of “0003” are defined in the facility information 172.

The calculating unit 163 calculates a distance between a position pointed as a vehicle parking position and each facility extracted by the extracting unit 162. A sketch object 173 in the storage unit 170 is used to calculate a distance.

FIG. 4 is an example of the sketch object 173. The sketch object 173 is information for creating a sketch relevant to the facility, and is also used to calculate a distance between the vehicle parking position and the facility.

As shown in FIG. 4, the sketch object 173 includes items of facility ID and object, and data is generated for each facility. The facility ID identifies a facility, and corresponds to the facility ID of the facility information 172. The object data includes vector data showing a shape of a facility, vector data showing a shape of the periphery of a facility, and basic data for measuring a distance between a vehicle and a parking position.

A plurality of numbers of the reference points can be set for each facility. The calculating unit 163 obtains a distance between each reference point and a vehicle parking position, and sets a shortest distance as a distance between a vehicle parking position and a facility. When a reference point is not set to a facility, a shortest distance between a vehicle parking position and the external periphery of the shape of the facility is obtained, and this distance is set as a distance between the vehicle parking position and the facility.

The selecting unit 164 compares the information on a facility extracted by the extracting unit 162 and a distance calculated by the calculating unit 163 with the illegal-parking application rule 174 in the storage unit 170, and selects a penalty article likely to be a basis of illegal parking as an application candidate.

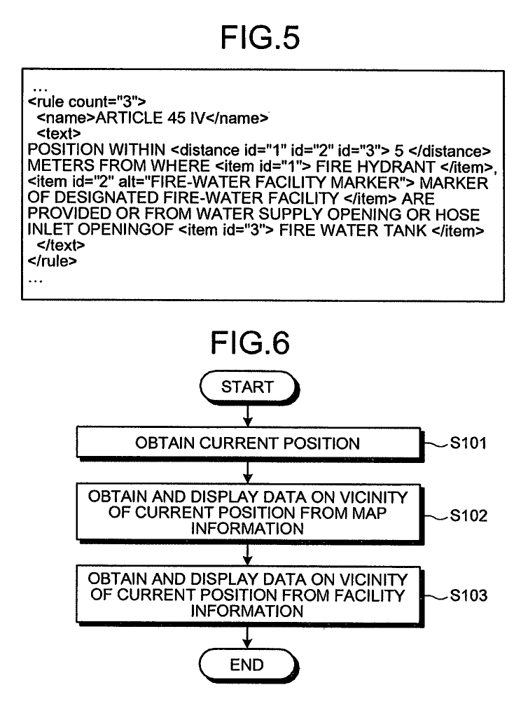

FIG. 5 is an example of the illegal-parking application rule 174. The illegal-parking application rule 174 defines a condition for identifying a case as illegal parking for each penalty article, and is described in a syntax similar to Extensible Markup Language (XML) as shown in FIG. 5.

In the illegal-parking application rule 174, an application rule for each penalty article is described by being encircled by a starting tag of <rule> and an ending tag of </rule>. The <rule> tag has an attribute called count, and this attribute expresses a number of facilities that become conditions of illegal parking in this penalty article.

Between the tag <rule> and the tag </rule>, there are described a text name of a penalty article between a tag <name> and a tag </name>, and an article of a penalty tag between a tag <text> and a tag </text>. Tags for defining a condition to identify illegal parking are further set in the text of the penalty article.

In the text of the penalty article, a portion between a tag <item> and a tag </item> expresses a facility that constitutes the illegal-parking condition, and facilities are present by the number of count attributes of the <rule> tag. The tag <item> has two attributes. One is an id attribute, and this is also an identifier for identifying a facility within a penalty article. The other is an alt attribute, where a separate name is set to be compared with a type of the facility information 172. When the alt attribute is not set, a comparison is performed using a name between the tag <item> and the tag </item>.

In the text of the penalty article, a portion between a tag <distance> and a tag </distance> expresses a condition of a distance from a facility. The tag <distance> has an id attribute, and a facility having the same value of the id attribute is related by this attribute.

In the text of the penalty article, a facility related to a distance becomes a valid condition for identifying illegal parking, when a distance between the vehicle parking position and the facility is smaller than this distance. A facility not related to a distance in the text of the penalty article becomes a valid condition for identifying illegal parking, when the vehicle is parked on a facility like a pedestrian crossing.

In the example of FIG. 5, a value of the count attribute of the tag <rule> is 3, and this means that three facilities the constitutes the illegal-parking condition are included in the penalty article. A character string between the tag <name> and the tag </name> is “article 45 IV”, and this is a text name of the penalty article.

In the text between the tag <text> and the tag </text>, three character strings of “fire hydrant”, “marker of designated fire-water facility”, and “fire water tank” are available, and identifiers “1”, “2”, and “3” are allocated. A separate name of “fire water sign” is set to the “marker of designated fire-water facility”.

A value of “5” is placed between the tag <distance> and the tag </distance>, and is related to identifiers of “1”, “2”, and “3”.

The application rule means that when there is a facility whose type is “fire hydrant”, “fire-water facility marker”, or “fire water tank” and which is within a distance of “5” meters from the point of the vehicle parking position in the information on facilities extracted by the extracting unit 162, the “article 45 IV” becomes a candidate of the basis of illegal parking.

As explained above, by setting a text set with a tag as a rule for selecting a penalty article, the rule can be securely set following the text. Because a tag is set to a part becoming a condition for selecting a penalty article, an important part can be easily displayed by highlighting, at the time of displaying a text to select an optimum penalty-article.

The candidate display unit 165 displays a list of penalty article selected by the selecting unit 164 in the display unit 110, and requests the user to select a penalty article to be applied. A list of penalty article is displayed by laying out text names based on a predetermined priority order.

When a user requests display of details of the penalty article, the candidate display unit 165 obtains a text corresponding to this penalty article from the illegal-parking application rule 174, and displays this text in the display unit 110. When display of the details of the “article 45 IV” is obtained from the list of the penalty article, a part between the tag <text> and the tag </text> in FIG. 5 is obtained and displayed. In this case, the parts of the “fire hydrant”, “marker of designated fire-water facility”, “fire water tank”, and “5” set with tags are displayed in highlight by changing colors, thereby clearly specifying that these are conditions important to select a penalty article.

The sketch creating unit 166 creates a sketch of a facility that is a valid condition for the penalty article selected by the candidate display unit 165 to be a basis of illegal parking. The facility being a valid condition is the one that matches the application rule of the selected penalty article out of the facilities extracted by the extracting unit 162.

The sketch is created from vector data showing a shape of a facility stored in the sketch object 173, and vector data showing a shape of the periphery of the facility. When a condition of distance is included in the application rule of a selected penalty article, an arrowhead line representing a distance between a vehicle parking position and the facility is also created.

The recording unit 167 records information on a penalty article selected by the candidate display unit 165 and a sketch and the like created by the sketch creating unit 166 as illegal-parking information 176 in the storage unit 170. The illegal-parking information 176 associates image data on a location picked up with the camera 140 with to these pieces of information.

The transmitting unit 168 transmits information stored in the illegal-parking information 176 to a central processing unit or the like via the communicating unit 150. The transmitted information is used for a charge process of penalty, after consistency of a penalty article, a sketch, and a camera image is checked.

The storage unit 170 stores various types of information, including the map information 171, the facility information 172, the sketch object 173, the illegal-parking application rule 174, the illegal-parking non-application rule 175, and the illegal-parking information 176. The information stored in the storage unit 170 is previously described, and the same description is not repeated.

FIG. 6 is a flowchart of a process procedure until display of a map to point a vehicle parking position.

As shown in FIG. 6, the map display unit 161 obtains the current position from the GPS 130 (step S101), obtains data on the vicinity of the current position from the map information 171, and displays the data in the display unit 110 (step S102). The map display unit 161 obtains information on facilities near the current position from the facility information 172, and displays the symbol of each facility on the map (step S103).

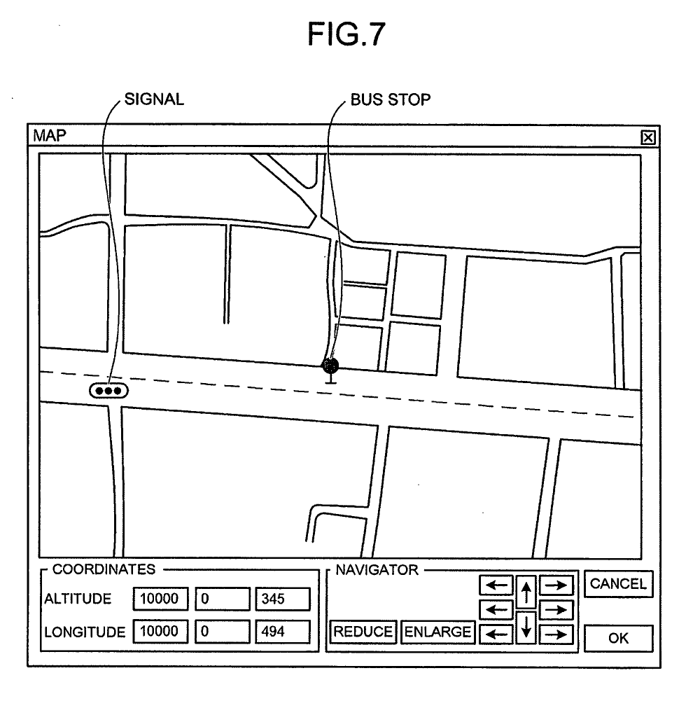

FIG. 7 is an example of map display by the map display unit 161. In the example of FIG. 7, a traffic signal and a bus stop are displayed as symbols on the map. When any one of the positions on the map is pointed and an OK button is pressed, the pointed position is specified as a vehicle parking position.

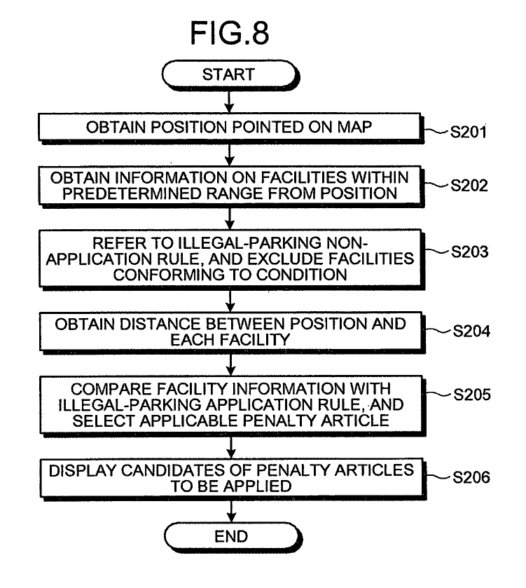

FIG. 8 is a flowchart of a process procedure until display of candidates of a penalty article to be applied to an unattended parked vehicle.

Upon obtaining information on a position pointed on a map (step S201), the extracting unit 162 obtains information on facilities within a predetermined latitude and longitude from the position from the facility information 172 (step S202). The extracting unit 162 refers to the illegal-parking non-application rule, and when the present time is not in the time zone in which a predetermined facility is not against the illegal parking, the information on this facility is excluded or removed from the obtained information (step S203).

Next, the calculating unit 163 calculates a distance between each facility in the obtained information and the position pointed on the map (step S204). The selecting unit 164 compares the information on each facility with the illegal-parking application rule 174. When the vehicle is illegally parked, The selecting unit 164 selects a penalty article that can be applied to the parked vehicle (step S205). The candidate display unit 165 displays a list of selected penalty articles (step S206).

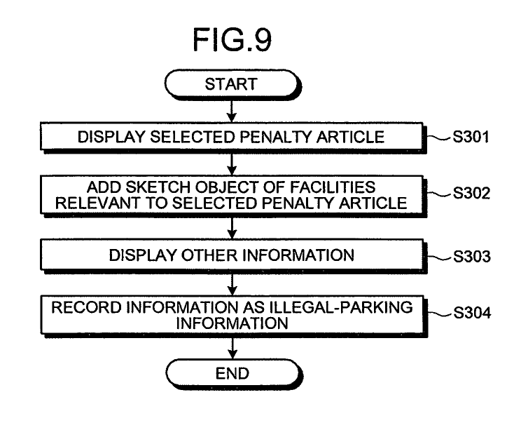

FIG. 9 is a flowchart of a process procedure until recording of information concerning illegal parking as the illegal-parking information 176. When a penalty article is selected in the list displayed by the candidate display unit 165, the selected penalty article is displayed on an illegal-parking information screen (step S301).

The sketch creating unit 166 creates a sketch of facilities which become valid conditions for the selected penalty article to become the basis of illegal parking, and adds this sketch to the illegal-parking information screen (step S302). Other relevant information is displayed on the illegal-parking information screen (step S303), and these pieces of information are recorded as the illegal-parking information 176 (step S304).

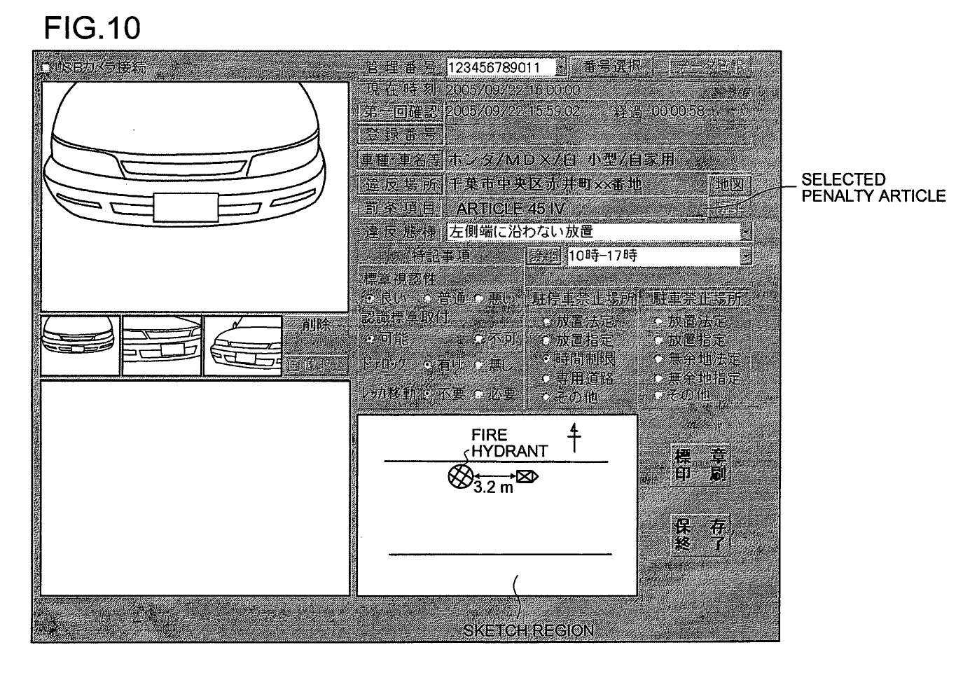

FIG. 10 is an example of the illegal-parking information screen. As shown in FIG. 10, information and images of an illegally-parked vehicle are displayed on the illegal-parking information screen together with a selected penalty article and a created sketch. These pieces of information are input before or after the above process procedure.

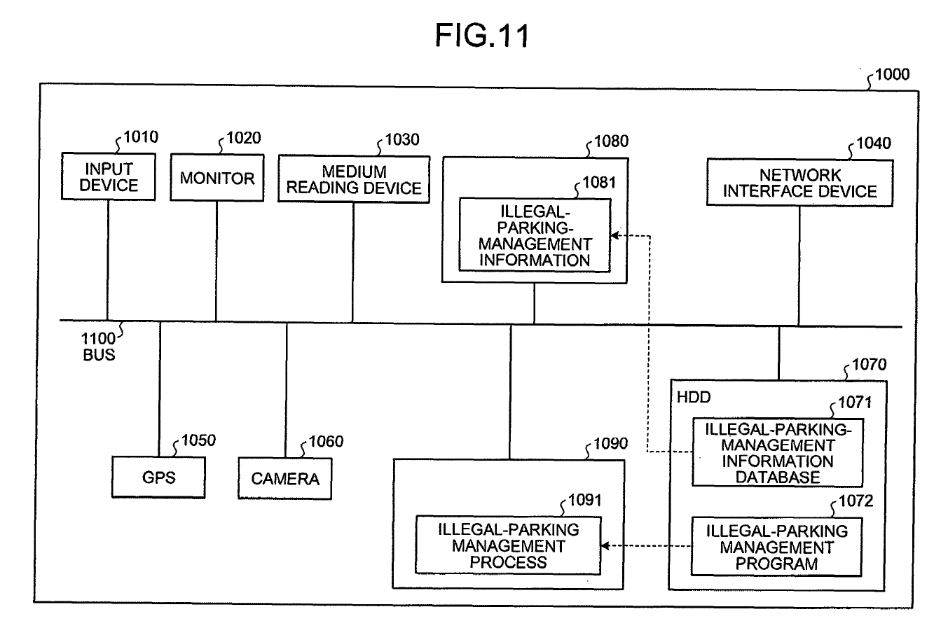

The illegal-parking-management portable terminal 100 is explained above as hardware; however, it can be implemented as software. In other words, a computer program (hereinafter, “illegal-parking management program”) can be executed on a computer to realize the same function as the illegal-parking-management portable terminal 100. In the following, such a computer is explained with reference to FIG. 11.

FIG. 11 is a functional block diagram of a computer 1000 that executes the illegal-parking management program. The computer 1000 includes an input device 1010, a monitor 1020, a medium reading device 1030, a network interface (I/F) 1040, a GPS 1050, a camera 1060, a Hard Disk Drive (HDD) 1070, a Random Access Memory (RAM) 1080, and a Central Processing Unit (CPU) 1090, which are connected by a bus 1100. The input device 1010 receives data input by a user. The medium reading device 1030 reads a computer program from a recording medium that stores therein various computer programs. The network I/F 1040 exchanges data with other computers via a network.

The HDD 1070 stores therein an illegal-parking management program 1072. The CPU 1090 reads the illegal-parking management program 1072 from the HDD 1070, and executes it to perform an illegal-parking management process 1091.

The HDD 1070 stores therein an illegal-parking-management information database 1071 corresponding to each type of information in the storage unit 170. The illegal-parking management process 1091 properly reads necessarily information from the illegal-parking-management information database 1071, stores the information in the RAM 1080 as illegal-parking-management information 1081, and executes various processes using the illegal-parking-management information 1081.

The illegal-parking management program 1072 need not necessarily be stored in the HDD 1070. The illegal-parking management program 1072 can be provided as being stored in a storage medium such as a Compact Disc-Read Only Memory (CD-ROM) to be executed. The illegal-parking management program 1072 can also be stored in another computer (or a server) connected to the computer 1000 via a network such as a public line, the Internet, a Local Area Network (LAN), or a Wide Area Network (WAN), so that the computer 1000 can downloads it therefrom.

As set forth hereinabove, according to an embodiment of the present invention, even a person with insufficient experience in illegal-parking management can easily specify, from among the candidate penalty articles, a penalty article to be applied to an unattended parked vehicle without fail.

Moreover, by only selecting a proper penalty article, a sketch necessary to report illegal parking can be created automatically.

Furthermore, based on a distance between a facility within a predetermined range from a vehicle parking position and the vehicle parking position, it is possible to accurately determine whether a penalty article, applicable conditions of which include such a distance, can be applied. Besides, the penalty-article application rule can be accurately defined without any omission of applicable conditions.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An illegal-parking-management portable terminal that supports management of illegal parking, the terminal comprising:
a storage unit that stores therein map information, facility information on a facility relevant to illegal parking, and a first illegal-parking rule that defines illegal-parking condition for each penalty article;
a display unit that displays a map based on the map information;
an extracting unit that extracts, from the facility information, information on a facility within a predetermined range from a position specified on the map as a vehicle parking position where a vehicle is parked; and
a selecting unit that compares extracted information with the first illegal-parking rule, and, when the vehicle parking position is designated as an illegal parking area, selects a penalty article to be applied to illegal parking of the vehicle.

2. The illegal-parking-management portable terminal according to claim 1, wherein the storage unit stores therein a sketch object for creating a sketch of the illegal parking area in association with the facility information, the terminal further comprising:
a creating unit that selects, from the extracted information, information on a facility that satisfies an applicable condition of a predetermined penalty article in relation to the vehicle parking position, and creates a sketch of the illegal parking area using a sketch object associated with the facility.

3. The illegal-parking-management portable terminal according to claim 1, further comprising a calculating unit that obtains a distance between the vehicle parking position and each facility indicated by the extracted information, wherein
the selecting unit selects the penalty article based on the extracted information, the distance obtained by the calculating unit, and the first illegal-parking rule.

4. The illegal-parking-management portable terminal according to claim 1, wherein the first illegal-parking rule is defined in a format in which predetermined tags bracket a portion of text in each penalty article corresponding to each item of the illegal-parking condition.

5. The illegal-parking-management portable terminal according to claim 1, wherein
the storage unit stores therein a second illegal-parking rule that defines a time zone in which a facility in the facility information does not constitute the illegal-parking condition, and
the extracting unit compares present time with the second illegal-parking rule, and removes information on a facility that does not constitute the illegal-parking condition at the present time from the extracted information.

6. A computer program product for supporting management of illegal parking, comprising a computer usable medium having computer readable program codes embodied in the medium that, when executed, causes a computer to execute:
displaying a map;
extracting, from facility information stored in advance, information on a facility within a predetermined range from a position specified on the map as a vehicle parking position where a vehicle is parked;
comparing extracted information with first illegal-parking rule that defines illegal-parking condition for each penalty article; and
selecting, when the vehicle parking position is designated as an illegal parking area, a penalty article to be applied to illegal parking of the vehicle.

7. The computer program product according to claim 6, further causing the computer to execute:
storing a sketch object for creating a sketch of the illegal parking area in association with the facility information;
selecting, from the extracted information, information on a facility that satisfies an applicable condition of a predetermined penalty article in relation to the vehicle parking position; and
creating a sketch of the illegal parking area using a sketch object associated with the facility.

8. The computer program product according to claim 6, further causing the computer to execute calculating a distance between the vehicle parking position and each facility indicated by the extracted information, wherein
the selecting includes selecting the penalty article based on the extracted information, the distance obtained at the calculating, and the first illegal-parking rule.

9. The computer program product according to claim 6, wherein the first illegal-parking rule is defined in a format in which predetermined tags bracket a portion of text in each penalty article corresponding to each item of the illegal-parking condition.

10. The computer program product according to claim 6, further causing the computer to execute storing a second illegal-parking rule that defines a time zone in which a facility in the facility information does not constitute the illegal-parking condition, wherein
the extracting includes comparing present time with the second illegal-parking rule, and removing information on a facility that does not constitute the illegal-parking condition at the present time from the extracted information.

11. An illegal-parking management method for supporting management of illegal parking, comprising:
displaying a map;
extracting, from facility information stored in advance, information on a facility within a predetermined range from a position specified on the map as a vehicle parking position where a vehicle is parked;
comparing extracted information with a first illegal-parking rule that defines illegal-parking condition for each penalty article; and
selecting, when the vehicle parking position is designated as an illegal parking area, a penalty article to be applied to illegal parking of the vehicle.

12. The illegal-parking management method according to claim 11, further comprising:
storing a sketch object for creating a sketch of the illegal parking area in association with the facility information;
selecting, from the extracted information, information on a facility that satisfies an applicable condition of a predetermined penalty article in relation to the vehicle parking position; and
creating a sketch of the illegal parking area using a sketch object associated with the facility.

13. The illegal-parking management method according to claim 11, further comprising calculating a distance between the vehicle parking position and each facility indicated by the extracted information, wherein
the selecting includes selecting the penalty article based on the extracted information, the distance obtained at the calculating, and the first illegal-parking rule.

14. The illegal-parking management method according to claim 11, wherein the first illegal-parking rule is defined in a format in which predetermined tags bracket a portion of text in each penalty article corresponding to each item of the illegal-parking condition.

15. The illegal-parking management method according to claim 11, further comprising storing a second illegal-parking rule that defines a time zone in which a facility in the facility information does not constitute the illegal-parking condition, wherein
the extracting includes comparing present time with the second illegal-parking rule, and removing information on a facility that does not constitute the illegal-parking condition at the present time from the extracted information.
